(19) United States
(12) Patent Application Publication
(10) Pub. No.: US 2016/0092190 A1
(43) Pub. Date: Mar. 31, 2016

(54) METHOD, APPARATUS AND SYSTEM FOR INSPECTING SAFETY OF AN APPLICATION INSTALLATION PACKAGE

(71) Applicant: BEIJING NQ TECHNOLOGY CO., LTD., Beijing (CN)

(72) Inventor: Ji Chen, Beijing (CN)

(73) Assignee: Beijing NQ Technology Co., Ltd., Beijing (CN)

(21) Appl. No.: 14/785,078

(22) PCT Filed: Dec. 11, 2014
(86) PCT No.: PCT/CN2014/093585

§ 371 Date: Oct. 16, 2015

(30) Foreign Application Priority Data
Dec. 16, 2013 (CN) 201310689652.6

(51) Int. Cl. G06F 9/445; H04L 29/06

(52) U.S. Cl. CPC G06F 8/61; H04L 63/10

(57) ABSTRACT

The invention provides a method, an apparatus and a system for inspecting safety when an application installation package is running. The method may comprise: detecting a running request of an application installation package at a terminal; analyzing the application installation package to obtain security key information, in response to the detection of the running request; comparing the acquired security key information with original security key information corresponding to the application; and terminating the running of the application installation package if the comparison result indicates that a difference is greater than a security threshold. Embodiments of the invention can efficiently identify and prevent applications maliciously tampered.

### TECHNICAL FIELD

The invention relates to the field of mobile communication, and particularly to a method, an apparatus and a corresponding system for inspecting safety of an application installation package.

### BACKGROUND

In recent years, mobile terminals are more and more popular. As used herein, the term “mobile terminal” may refer to devices capable of wireless communication, such as smart phones, wireless PDAs, laptop computers, tablet computers, etc. Various applications can be installed on such mobile terminals for using various functions such as transmitting/receiving an email, accessing a social network, e-shopping, gaming, etc. These applications enrich the usage experiences of the user of the terminals. However, it is very difficult for a user to identify whether an application (particularly, its installation package) he/she downloaded from a network site was embedded with an illegal application by a third party for various purposes, resulting in a vast security risk when the user uses various applications.

Nowadays, a security method for enhancing security of an application by performing process on the application itself has been proposed, in order to prevent against the malicious behaviors in the market of repacking the application to embed illegal applications. This is generally achieved by typical means such as converse analysis and source code reinforcement, so as to decrease the risk of the application being maliciously tampered. For example, the source code information of the application may be prevented from being read by tools such as the apktool by using code confusion, key API encryption, and so on.

Though the above preventive method of enhancing the application itself can greatly guarantee the safety of the application, it has some disadvantages. For example, once the application is updated, e.g. when the version is upgraded, the application or its source code should be enhanced again with respect to the new version of the application. Such a processing is trivial and time consuming. Furthermore, such a processing has a security vacant period because the real time synchronization between the enhancement of the application and the updating operation of the application (such as version upgrade of the application) cannot be guaranteed.

### SUMMARY

In order to address part or all of the above disadvantages and efficiently prevent the malicious behaviors of repacking the application to embed the illegal applications, a cloud based method and apparatus for inspecting safety of an application installation package when installing the application and a corresponding system are provided. According to the embodiments of the invention, whether the application has been tampered or not can be detected when the application is being installed. Additionally, based on the detection result, the running of the application which has been illegally tampered (or maliciously re-packed) can be terminated and the user can be alerted.

According to an aspect of the invention, a method for inspecting safety when an application installation package is running is provided. This method may comprise: detecting a running request of an application installation package at a terminal; analyzing the application installation package to acquire security key information, in response to the detection of the running request; comparing the acquired security key information with original security key information corresponding to the application; and terminating the running of the application installation package if the comparison result indicates that a difference is greater than a security threshold.

In some embodiments of the invention, the method may further comprise: prompting a user whether to replace the application installation package with an original application installation package corresponding to the application when terminating the running of the application installation package; and acquiring the original application installation package from a cloud server in response to an positive acknowledgement received from the user.

In some embodiments of the invention, the security key information comprises file attributes and version information. Furthermore, the security key information may also comprise at least one of the HASH abstract of a file, the characteristic fingerprint of contents, and/or the key API information.

In some embodiments of the invention, the method may further comprise: inquiring an original secure identification Database stored locally at the terminal for the original security key information corresponding to the application; and, when the inquiry performed locally at the terminal fails, inquiring the cloud server for the original security key information corresponding to the application.

In some embodiments of the invention, the method may further comprise: when the inquiry to the cloud server fails, requesting the cloud server to generate the original security key information corresponding to the application in real time; and receiving the original security key information returned from the cloud server. The cloud server may acquire an official application installation package corresponding to the application in response to the request; analyze the official application installation package to generate the original security key information, and return the original security key information to the terminal.

According to another aspect of the invention, an apparatus for inspecting safety when an application installation package is running is provided. This apparatus may comprise a monitoring module, an analyzing module, an inquiring module, a comparing module and a processing module. The monitoring module may be configured for detecting a running request of an application installation package at a terminal. The analyzing module may be configured for analyzing the application installation package to acquire security key information, in response to the detection of the running request. The inquiring module may be configured for inquiring original security key information corresponding to an application. The comparing module may be configured for comparing the acquired security key information with the original security key information corresponding to the application. The processing module may be configured for terminating the running of the application installation package if the comparison result indicates that a difference is greater than a security threshold.

In some embodiments of the invention, the security key information comprises file attributes and version information. Furthermore, the security key information may also comprise at least one of the HASH abstract of a file, the characteristic fingerprint of contents, and/or the key API information.

In some embodiments of the invention, the apparatus may further comprise: a prompting module configured for prompting a user whether to replace the application installation package with an original application installation package corresponding to the application when terminating the running of the application installation package. The apparatus may further comprise: a communication module configured for acquiring the original application installation package from a cloud server in response to a positive acknowledgement received from the user.

In some embodiments of the invention, the inquiring module may further comprise: a local inquiring module configured for inquiring an original secure identification Database stored locally at the terminal for the original security key information corresponding to the application; and, a remote inquiring module configured for, when the inquiry performed locally at the terminal fails, inquiring the cloud server for the original security key information corresponding to the application.

In some embodiments of the invention, the inquiring module may further comprise: a supplementing module configured for requesting the cloud server to generate the original security key information corresponding to the application in real time when the inquiry to the cloud server fails; and receiving the original security key information returned from the cloud server. The cloud server may acquire an official application installation package corresponding to the application in response to the request; analyze the official application installation package to generate the original security key information, and return the original security key information to the terminal.

According to another aspect of the invention, a system for inspecting safety when an application installation package is running is provided. The system comprises a mobile terminal and a cloud server, wherein the mobile terminal may comprises the above apparatus for inspecting safety when an application installation package is running, and the cloud server may comprises an original secure identification Database containing the original security key information for a plurality of applications.

### BRIEF DESCRIPTION OF THE DRAWINGS

The above and other purpose, features and advantages of the invention will be more clear from the following description of preferred embodiments of the invention, in connection with the figures where:

FIG. 1 illustratively shows a schematic application scenario of the mobile communication system according to the invention;

FIG. 2 illustratively shows a flowchart of a method for inspecting safety when an application installation package is running according to an embodiment of the invention;

FIG. 3 illustratively shows a block diagram of an apparatus for inspecting safety when an application installation package is running according to an embodiment of the invention; and

FIG. 4 illustratively shows a schematic diagram of a process for inspecting safety when an application installation package is running according to an example of embodiments of the invention.

The same or like elements in the figures are identified by the same or like reference numbers throughout the figures of the invention.

### DETAILED DESCRIPTION

The invention will be described in detail referring to the figures which show illustrative embodiments of the invention so that one with ordinary skills in the art can implement the invention. It should be noted that the following figures and examples do not intend to limit the scope of the invention to a single embodiment. In contrast, it is possible to form other embodiments of the invention by interchanging or combining some or all of the illustrated elements of different embodiments. Furthermore, in case a specific element of the invention can be partly or completely implemented by a known component, only the part of the component which is necessary to the understanding of the invention will be described, and the detailed description of other parts of the component will be omitted, in order to make the invention more clear. Unless explicitly pointed out, one with ordinary skills in the art should understand that, although some embodiments of the invention are described as being implemented in the form of software, the invention should not limited to this, but rather can be implemented in hardware, software, or combination of them, and vice versa. Unless explicitly pointed out, the embodiments showing a single component in the description should not be interpreted as limiting, but rather intends to include other embodiments including more than one identical components, and vice versa. Furthermore, the invention includes current and future equivalences of known components provided in the text as an illustration.

As stated above, in order to efficiently prevent malicious behaviors such as re-packing the application to embed an illegal application, the invention provides a cloud-based mechanism for inspecting safety when an application installation package is running. This security inspection mechanism may judge whether the application was illegally tampered by checking the security key information against the original information of the application. Herein the term “original application” refers to a terminal application which is tested and validated by the official party and a third party and which is officially issued to the market by the official sellers after the application was issued by the developer. The term “original information” refers to information associated with this kind of original application. Or in brief, the phase “original” means an intrinsical attribute of the terminal application which is officially issued to the market by the official sellers (not the re-packed application).

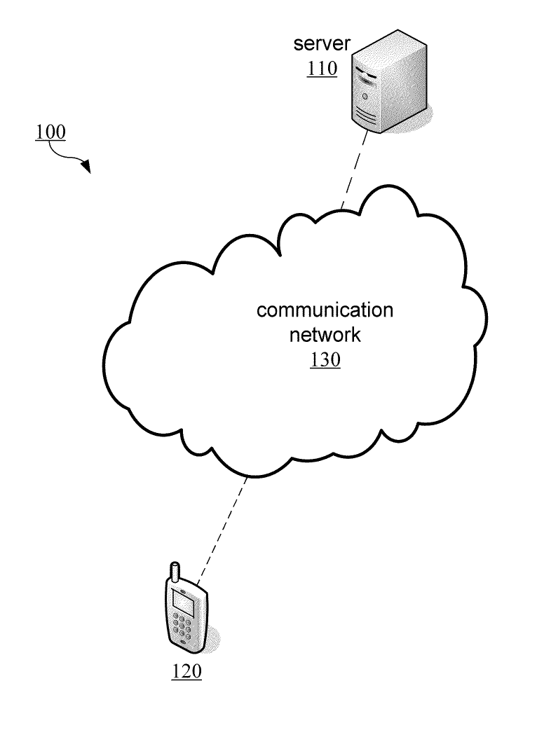

FIG. 1 is a schematic diagram of the mobile communication system 100 in which the embodiments of the invention can be implemented. As shown in FIG. 1, system 100 may include a server 110 and a terminal 120.

Server 110 may usually be a safe cloud server. Server 110 may acquire, from an official web site, a sample of the application in a safe status when the application was officially issued. Server 110 may also analyze the application sample, acquire the basic security key information (BSKI) of the application sample, and form an original secure identification Database (SID) of the application. The basic security key information may include file attributes, version information, HASH abstract of a file, characteristic fingerprint of contents, key API information, etc. The SID may be used as a safety judgment criterion for an application integrality check performed in a later time when the application is being installed.

The SID may store BSKI information or other related information of the application for example by using MySQL, and store the security key information which is encrypted (for example, using DES and so on). As for the application with a number of versions, the SID may maintain respective BSKI information for respective versions of the application. In an embodiment, the BSKI information of an application may include a plurality of tables which are classified according to the version they belong to, such as table BSKI_23, table BSKI_40, etc. Table BSKI_23 represents BSKI to which the version 2.3 corresponds, while table BSKI_40 represents BSKI to which the version 4.0 corresponds. Other related information contained in the SID may, for example, include: legal application market (LAM) information, version history (VH) information, etc. It should be understood that the above mentioned MySQL and DES are only examples to which the invention should not be limited. In other embodiments, other suitable database management systems and other suitable encryptions (such as 3DES, AES or RSA) may also be used to safely store the information.

The SID may be updated periodically. Particularly, server 110 may periodically inquire official updates of all the application stored in the SID, and update the BSKI information of the updated application. Accordingly, respective BSKI information for different versions of the application in its lifetime may be established and maintained.

Although only one server 110 is shown in the figure, it should be understood that two or more server 110 may also be impossible. Furthermore, server 110 may be a single physical entity, or may be distributed over two or more physical entities.

Terminal 120 may be a mobile terminal having a wireless communication capacity such as a mobile phone, a tablet computer, a laptop computer, a personal digital assistant (PDA), etc. Optionally, terminal 120 may also be a device having a wired networking capacity but immobile, such as a desktop computer. The apparatus for inspecting safety when an application installation package is running according to an embodiment of the invention may be installed on terminal 120 in the form of a client. The client may be installed automatically on terminal 120 in the form of software, or installed by the terminal manufactory on terminal 120 in the form of hardware or firmware.

A local SID may be stored on terminal 120. Information in the local SID may originate from a safe cloud server, and may include part or all of the information in the SID of the safe cloud server. Preferably, due to the limited storage capacity of terminal 120, SID information of the most often used application (often-used SID, OSID) may be maintained at the terminal locally. The OSID is formed by information extracted from the complete SID database of a remote server. The OSID may, for example, be in the form of a XML file and safely stored at a specified location of the terminal locally by means of cryptography. For example, the OSID may be stored as /sdcard/appSafeCheck/osid.xml.

It should be understood that, similar to the SID on the server, the SID on the terminal locally may be periodically updated.

It should be understood that though only one terminal 120 is shown in the figure, two or more terminal are also impossible. Although the embodiment of the invention will be described below taking an Android mobile phone as an example of terminal 120, the invention does not be limited to this. In embodiments of the invention, the operation system of terminal 120 may include but not limited to Android, iOS, Windows Mobile, Symbian, Windows Phone, Blackberry OS, etc.

As shown in the figure, terminal 120 may communicate with server 110 via a network 130. Network 130 may be a wireless network, or a wired network, such as a 2G, 3G, 4G or 5G mobile communication network (for example WCDMA, CDMA 1100, TD-SCDMA, LTE, etc.), the internet, a wired local area, or a wireless local area, etc.

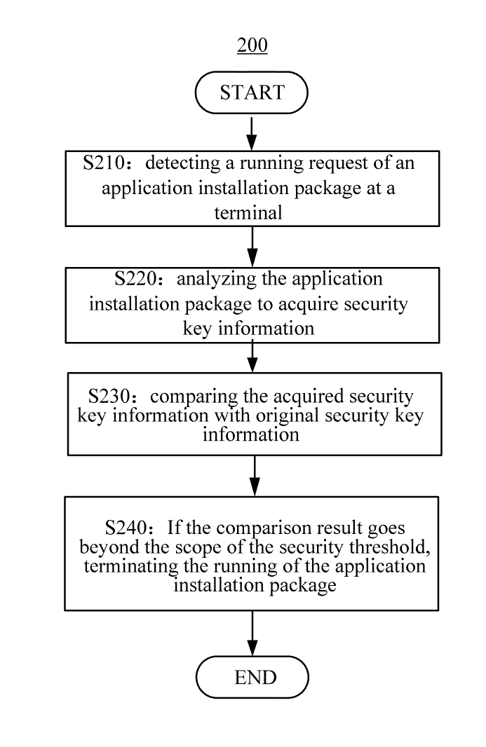

FIG. 2 illustratively shows a flowchart of a method 200 for inspecting safety when an application installation package is running according to an embodiment of the invention. Method 200 may be performed by a client according to an embodiment of the invention which is installed on terminal 120. The client may be automatically enabled when terminal 120 is powered on, or may be enabled by the user voluntarily. When the client is running, it will continuously monitor application installation events on terminal 120.

In Step S210, a running request of an application installation package is detected at the terminal. The application installation package may be, for example, downloaded from a mobile application store on the internet or acquired by other method to make it available at terminal 120.

If the running request for an application installation package is detected in the terminal, the method proceeds to Step S220. In Step S220, the application installation package is analyzed to acquire security key information. The security key information includes the file attributes and version information, and may also include at least one of the HASH abstract of a file, the content characteristic fingerprint, and/or the key API information. It should understood that information elements contained in the security key information analyzed and acquire here may be the same as those stored in the original secure identification Database, or may be only part of them.

In Step S230, the security key information acquired in Step S220 is compared with original security key information corresponding to the application.

The original security key information corresponding to the application may be acquired from a local secure identification Database, or from a cloud server 110.

In a preferred embodiment of the invention, a complete original secure identification Database for applications (complete database in brief) is maintained on a safe cloud server (such as server 110), while an incomplete original secure identification Database for applications is maintained locally on the terminal to fit the storage with limited capacity on the terminal. Preferably, the SID information of the most often used application (often-used SID, OSID) may be maintained at the terminal locally. The OSID may, for example, be cryptographically stored at a specified location of the storage on the terminal in the form of a file. In the preferred embodiment of the invention, the original security key information corresponding to the application may be acquired as follows. Firstly, the original security key information corresponding to the application to be installed, which is detected in Step S210, may be inquired in the original secure identification Database (for example, OSID) stored locally at the terminal. If no original security key information corresponding to the application is found in the OSID, the terminal may inquire cloud sever 110 for the original security key information.

In another embodiment, the terminal does not store locally the original secure identification Database for applications. Therefore, cloud server 110 may be inquired directly for the original security key information of the application.

It should be understood that, in some other embodiments of the invention, if terminal 120 has an enough storage capacity, a complete database for the original secure identification Database may be maintained on terminal 120, and may be synchronized at regular intervals with the original secure identification Database on server 110. In this case, only the local database on the terminal should be inquired to determine the original security key information of the application. If no original security key information matched with the application was inquired locally, it can be determined that the inquiry has been failed and no inquiry will be made to the server.

In any of the above embodiments, if the inquiry to cloud server 110 for the original security key information of the application fails (i.e. no original security key information corresponding to the application is found in the complete SID database on the cloud server), the user may be prompted that the original security key information of the application cannot be acquired and whether the installation of the application should continue or not. Then method 200 is ended. Alternatively, if the inquiry to cloud server 110 for the original security key information of the application fails, the terminal may further send to the server a request for generating the original security key information of the application. The request may include identification information of the application (such as the application ID). In response to the reception of the request from the terminal, the cloud sever may acquire an official application installation package corresponding to the application from an official location, and analyze the official application installation package to generate the original security key information. Then the cloud server may return the generated original security key information to the terminal.

In Step S230, comparing the acquired security key information with original security key information may be performed by comparing matched information elements contained in both of them one by one. If the difference between them goes beyond a security threshold, it can be judged that the application was illegally tampered, or otherwise, the application is a legal one. As an example of the judging criterion, the difference between them being higher than a security threshold may include: the HASH abstract has been changed, the difference between characteristic fingerprints of their contents is higher than 40%, or amendments made to the key API information violates the security requirements, etc.

If the comparison result of Step S230 indicates that it goes beyond the scope of the security threshold, the method proceeds to Step S240, terminating the running of the application installation package. Meanwhile, a prompt that the application has been illegally tampered is provided to the user. For example, this prompt may be implemented by displaying a text message on a display or playing a voice message by a speaker.

If the comparison result of Step S230 indicates that it is in the scope of the security threshold, the application is judged as a legal one. Thus the application installation package may be kept running and method 200 is then ended.

Optionally, method 200 may further include, after Step S240, a step of acquiring the original application. Particularly, the user may be prompted whether to replace the current application installation package with an original application installation package of the application. If the user determines that the replacement is required, the terminal may download the original application installation package from the cloud server, and then install the original application installation package. If the user does not choose to replace the current application installation package, method 200 is ended directly.

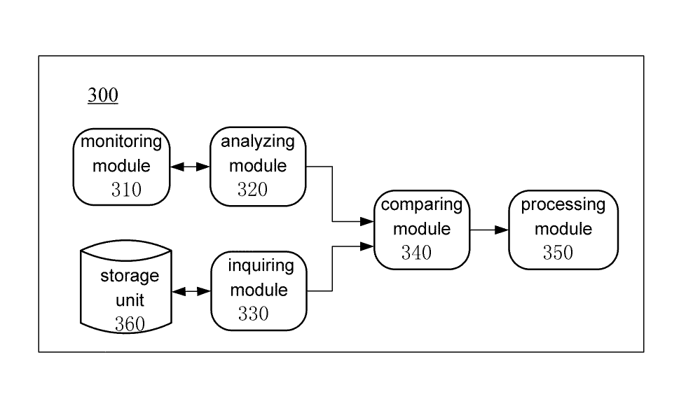

FIG. 3 illustratively shows a block diagram of an apparatus 300 for inspecting safety when an application installation package is running according to an embodiment of the invention. As shown, apparatus 300 may include: a monitoring module 310, an analyzing module 320, an inquiring module 330, a comparing module 340, a processing module 350 and a storage unit 360.

Monitoring module 310 may be used for detecting a running request of an application installation package at a terminal. Analyzing module 320 may be used for analyzing the application installation package to acquire security key information, in response to the detection of the running request. Inquiring module 330 may be used for inquiring original security key information corresponding to an application. Comparing module 340 may be used for comparing the acquired security key information with the original security key information corresponding to the application. Processing module 350 may be used for terminating the running of the application installation package if the comparison result indicates that a difference is greater than a security threshold.

Optionally, processing module 350 may be configured for: prompting the user that the application installation package has been illegally tampered when terminating the running of the application installation package. For example, this prompt may be provided to the user by displaying a text message on a display or playing a voice message by a speaker.

Optionally, apparatus 300 may further include a prompting module and a communication module. The prompting module may be configured for prompting a user whether to replace the application installation package with an original application installation package corresponding to the application. The communication module may communicate with the cloud server and may be configured for acquiring the original application installation package from the cloud server in response to a positive acknowledgement received from the user to indicate that the replacement is required.

Monitoring module 310, analyzing module 320, inquiring module 330 and comparing module 340, and processing module 350 may implement Steps S210, S220, S230, and S240 in the above method 200 respectively. The prompting module and the communication module may implement the step of acquiring the original application in the above method 200. Description of them will not be provided repeatedly.

Storage unit 360 may store a local original secure identification Database (e.g. OSID) for applications. Optionally, storage unit 360 may also store other information such as the logs during the process of the application installation. Storage unit 360 may be implemented by one or more storages which may be arranged at a single physical entity or distributed over different physical entities. The storage unit may be implemented by any storage techniques well known to one with ordinary skills in the art, and the invention will not be limited thereto. Storage unit 360 may, for example, include a magnetic disk, a magnetic-optical disk, an optical disk, a semi-conductive storage, and so on.

As stated above, apparatus 300 may be installed on terminal 120 as a client or part of the client. The client may be installed automatically on terminal 120 in the form of software, or installed by the terminal manufactory on terminal 120 in the form of hardware or firmware. The client may be automatically enabled when terminal 120 is powered on, or may be enabled by the user voluntarily. When the client is running, method 200 may be performed.

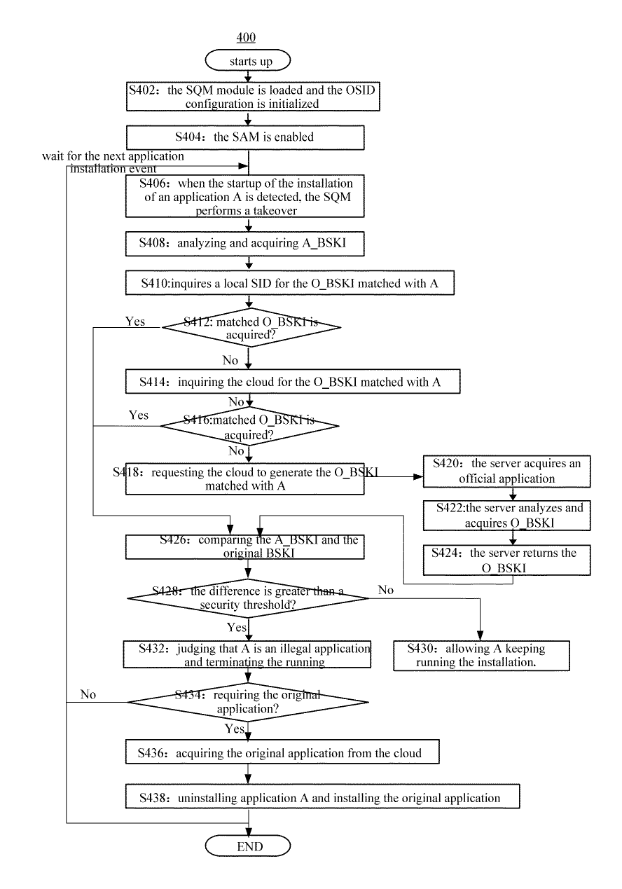

A particular implementation of the invention will be introduced by referring to FIG. 4, taking the case where the invention is applied to a mobile phone using an Android operation system as an example.

FIG. 4 illustratively shows a schematic diagram of a process 400 on an Android mobile phone for inspecting safety when an application installation package is running according to an example of embodiments of the invention.

In this embodiment, the security detection function may be implemented mainly by two functional modules such as Security Application module (SAM) and Security Query Module (SQM). The SAM application may be designed by using Java language in connection with Android SDK. The main function of the SAM is in charge of the SID update setting, monitoring the SQM security inquiring, and the log data management during the security inquiring process. The SAM may be running at the application layer of the terminal system in the form of a service. Configuration information may be stored at a specified location in the form of plaintext, such as /sdcard/appSafeCheck/samConfig.

The SQM module may be designed by using C++ language in connection with Android NDK. The SQM may be in charge of the running application analysis and information abstraction, the security status inquiry, and the application running status control. The SQM module usually operates in the kernel layer in the form of a kernel module.

All the log information generated during the operations of the SAM and the SQM can be cryptographically (e.g. DES encryption) stored at a specified location, such as /sdcard/appSafeCheck/checkLog. Typically, only the cloud server or the SAM itself can decrypt these logs to view by using a preset key.

Process 400 starts with the startup of the system (i.e. when the mobile phone powers on). After the system has loaded key services, in Step S402, the SQM module is loaded and initialized. Particularly, up-to-date configuration information of a SID file is read from a file at a specified location (such as the samConfig) and loaded in the memory. The configuration information includes, for example, information related to the database of the SID, such as the database address, the database username, the password, the encoding method used for storage, etc. Then the SID file (such as the osdi.xml) is read according to the configuration information. The SID information of the most often used application may be acquired from the SID file by decryption, and then loaded into the memory in the form of KEY-VALUE. The KEY may be the name or identification of the application. The VALUE may be implemented by a data structure and contains a number of pieces of security key information corresponding to the application. After the loading and initialization of the SQM have been completed, the SQM module will monitor an application installation event, and perform security detection for the application installation package to be installed.

In Step S404, the SAM is enabled.

In Step S406, when the SQM detects an application installation event (such as the running request from the application installation package A), the SQM takes over the startup of the application installation package A.

In Step S408, the SQM analyzes the application installation package A, and acquires key application elements A_BSKI such as the needed file attributes, the version information, the HASH abstract of the file, the content characteristic fingerprint, and/or the key API information.

In Step S410, the SAM inquires a local SID for the original key application element O_BSKI matched with the application installation package A. Particularly, the SQM inquires the OSID information stored in the memory and searches the matched item by using the application name or ID of the application installation package A as a key.

If it is determined in Step S412 that an original BSKI (O_BSKI) matched with the application installation package A is found, the SQM proceeds to perform Step S426, and continues sequent security detection. However, if it is determined in Step S412 that no matched information is found in the OSID, the process proceeds to Step S414.

In Step S414, the SQM sends an inquiry request to cloud server 110. The server, in response to this request, searches the complete SID database on the server for the security key information matched with the application installation package A.

If the security key information matched with the application installation package A is found, the cloud server may cryptographically return the search result to the SQM (the “yes” branch in Step S412), and then the process proceeds to Step S426, continuing the sequent security detection.

If the security key information matched with the application installation package A cannot be found in the complete SID database of the cloud server, the cloud will return the SQM a search result of failure (the “no” branch in Step S416). The SQM, upon receiving this message, will proceed to Step S418 and request the cloud server to generate an original BSKI (O_BSKI) corresponding to the application installation package A. Particularly, the SQM sends cryptographically, from the terminal to the cloud server, the key identification information (KID) of the application installation package A using an agreed transmission method with the cloud server. Then, in Step S420, the cloud server acquires an officially issued application installation package matched with the application installation package A from a specified official location according to the KID. In Step S422, the server analyzes the officially issued application installation package, and acquires the original key application element (O_BSKI). Meanwhile, the server may update the complete SID database and/or the osid.xml file according to the newly acquired O_BSKI. Then, in Step S424, the server returns cryptographically the newly acquired F_BSKI information and/or the updated osid.xml file to the SQM.

After acquiring the original key application element (O_BSKI) corresponding to the application installation package A, in Step S426, the server performs a security comparison for the A_BSKI and the O_BSKI. Particularly, the security comparison is performed by differentiating information items of the A_BSKI and the O_BSKI, such as the file attributes, the version information, HASH abstract of the file, the content characteristic fingerprint, and/or the key API information.

If it is found in Step S428 that the difference between the A_BSKI and the O_BSKI goes beyond the scope of the security threshold (for example, the HASH abstract has been changed, the difference between the content characteristic fingerprints is higher than 40%, or amendments made to the key API information violates the security requirements, etc.), the process proceeds to Step S432.

In Step S432, the SQM judges that the application installation package A has been tampered, and then the SQM sends a system message to prompt the system process to start up, and to control the module to terminate the startup process of the application installation package A. Meanwhile, a prompt can be sent to the user.

If it is found in Step S428 that the difference between the A_BSKI and the O_BSKI is in the scope of the security threshold, the process proceeds to Step S430. In Step S430, the SQM allows the application installation package A keeping running and retrocedes the startup control to the system process management module. As such, the application security detection at the time of the startup of the application installation package A is completed.

The prompt to the user in S432 may ask the user whether to replace the application installation package A, which was judged as illegal, with an original application installation package.

If, in Step S434, a positive acknowledgement from the user for confirming that the illegal application should be replaced is received, the process proceeds to Step 5436. In Step S436, the SQM downloads an original application installation package from the cloud server. Then, in Step S438, the SQM uninstalls the current illegal application installation package, and installs the original application installation package downloaded from the server. The process then returns to Step S406, monitoring the next application installation event.

If the user does not choose to replace the current application in Step S434, after the SQM terminates the startup of the application installation package A, the process returns to Step S406, monitoring the next application installation event.

In process 400, the SAM may manage logs generated during the whole security detection process, and may cryptographically (e.g. DES encryption) store the generated logs at a specified location, such as /sdcard/appSafeCheck/checkLog.

Referring to FIG. 4, the above describes a process 400 on an Android mobile phone for inspecting safety when an application installation package is running. In this example, the SQM may be implemented by the apparatus 300 described by referring to FIG. 3, and thus will not be repeatedly described.

It should be understood that process 400 provides many details of the security detection when an application installation package is running, but the embodiments of the invention can also be implemented without these details.

The above describes the invention in connection with the preferred embodiments. One with ordinary skills in the art may understand that the method and apparatus shown above are only examples. The method of the invention should not be limited to the steps and orders shown above. The apparatus of the invention can include more or less components than those shown. One with ordinary skills in the art can make many changes and modifications in light of the teaching of the embodiments.

The apparatus of the invention or parts thereof can be implemented by, for example, super-large-scale integrate circuitry or gate array, semiconductors such as logic chips and transistors, or hardware circuitry of a programmable hardware device such as field programmable gate array and programmable logic devices, or can be implemented by software executed by various processors, or the combination of the above hardware circuitry and software.

The invention may provide many advantages. The cloud based mechanism for inspecting safety of an application when installing the application can judge whether the application has been tampered or not when the application installation package is started up and loaded. Then, based on the security detection result, corresponding security control action will be taken for the application which has been illegally tampered or maliciously re-packed, for example, the running of the application may be terminated, a reminding message may be provided to the user, and so on.

It should be understood that although the invention is described by using particular embodiments, the protection scope of the invention should not be limited to these particular embodiments. Instead, the protection scope of the invention should be defined by the attached claims or equivalences thereof.

1. A method for inspecting safety of an application installation package when the application installation package is running, comprising:
detecting a running request of the application installation package at a mobile terminal;
analyzing the application installation package to acquire security key information of the application installation package, in response to the detection of the running request;
comparing the acquired security key information with original security key information corresponding to the application; and
rejecting the running request if the comparison result indicates that a difference between the acquired security key information and the original security key information is greater than a security threshold.

2. The method of claim 1, further comprising:
prompting a user whether to replace the application installation package running at the mobile terminal with an original application installation package corresponding to the application; and
acquiring the original application installation package from a cloud server in response to an positive acknowledgement received from the user.

3. The method of claim 1, wherein the security key information comprises file attributes and version information, and further comprises at least one of HASH abstract of a File, characteristic fingerprint of contents, and/or key API information.

4. The method of any of claim 1, further comprising:
inquiring an original secure identification database stored locally at the terminal for the original security key information corresponding to the application; and
when the inquiry performed locally at the terminal fails, inquiring the cloud server for the original security key information corresponding to the application.

5. The method of claim 4, further comprising:
when the inquiry to the cloud server fails, requesting the cloud server to generate the original security key information corresponding to the application in real time, and receiving the original security key information returned from the cloud server,
wherein the cloud server acquires an official application installation package corresponding to the application in response to the request, analyzes the official application installation package to generate the original security key information, and returns the original security key information to the terminal.

6. A mobile terminal, comprising:
a processor; and
a memory containing instructions, which, when executed by the processor, cause the processor to:
detect a running request of an application installation package in the mobile terminal;
analyze the application installation package to acquire security key information of the application installation package, in response to the detection of the running request;
compare the acquired security key information with the original security key information corresponding to the application; and
rejecting the running request if the comparison result indicates that a difference between the acquired security key information and the original security key information is greater than a security threshold.

7. The mobile terminal of claim 6, wherein, when executed by the processor, the instructions further cause the processor to:
prompt a user whether to replace the application installation package running at the mobile terminal with an original application installation package corresponding to the application; and
acquire the original application installation package from a cloud server in response to an acknowledgement received from the user.

8. The mobile terminal of claim 6, wherein, when executed by the processor, the instructions further cause the processor to:
inquire an original secure identification database stored locally at the terminal for the original security key information corresponding to the application; and
when the inquiry performed locally at the terminal fails, inquire the cloud server for the original security key information corresponding to the application.

9. The mobile terminal of claim 8, wherein, when executed by the processor, the instructions further cause the processor to:
when the inquiry to the cloud server fails, request the cloud server to generate the original security key information corresponding to the application in real time, and receive the original security key information returned from the cloud server,
wherein the cloud server acquires an official application installation package corresponding to the application in response to the request, analyzes the official application installation package to generate the original security key information, and returns the original security key information to the terminal.

10. A system for inspecting the safety when an application installation package is running, comprising:
a mobile terminal, comprising an apparatus of claim 6; and
a cloud server, comprising an original secure identification database containing the original security key information for a plurality of applications.
